(19) United States
(12) Patent Application Publication
(10) Pub. No.: US 2020/0320428 A1
(43) Pub. Date: Oct. 8, 2020

(54) FAIRNESS IMPROVEMENT THROUGH REINFORCEMENT LEARNING

(71) Applicant: International Business Machines Corporation, Armonk, NY (US)

(72) Inventors: Georgios Chaloulos, Zurich (CH); Frederik Frank Flöther, Schlieren (CH); Florian Graf, Zurich (CH); Patrick Lustenberger, Zurich (CH); Stefan Ravizza, Wallisellen (CH); Eric Slottke, Zurich (CH)

(21) Appl. No.: 16/377,727

(22) Filed: Apr. 8, 2019

(51) Int. Cl. G06N 20/00; G06N 3/08

(52) U.S. Cl. CPC G06N 20/00; G06N 3/08

(57) ABSTRACT

A computer-implemented method for improving fairness in a supervised machine-learning model may be provided. The method comprises linking the supervised machine-learning model to a reinforcement learning meta model, selecting a list of hyper-parameters and parameters of the supervised machine-learning model, and controlling at least one aspect of the supervised machine-learning model by adjusting hyper-parameters values and parameter values of the list of hyper-parameters and parameters of the supervised machine-learning model by a reinforcement learning engine relating to the reinforcement learning meta model by calculating a reward function based on multiple conflicting objective functions. The method further comprises repeating iteratively the steps of selecting and controlling for improving a fairness value of the supervised machine-learning model.

### FIELD OF THE INVENTION

The invention relates generally to a method for improving machine-learning, and more specifically, to a computer-implemented method for improving fairness and reducing discriminatory bias in a supervised machine-learning model (SML). The invention relates further to a related fairness improvement system for improving fairness in a supervised machine-learning model, and a computer program product.

### BACKGROUND

Artificial intelligence, machine-learning and/or cognitive computing are currently one of the hottest topics in research as well as implementations in enterprises. In recent years, there has been a proliferation of artificial intelligence (AI) approaches and applications. However, the results of a trained machine-learning model are only as good as the underlying training dataset. This is one of the reasons why parts of the society and certain industry groups are cautious regarding a first adoption of AI technologies. Bias, defined here to be a systematic preference given to certain privileged subgroups, has been noted as a major problem an impediment for further AI progress.

Predictions have been made that AI bias will explode, but only the unbiased AI will survive. Thus, given that there are also relevant anti-discrimination laws around the world, mitigating bias in machine-learning models is a key concern nowadays.

AI is certainly one of the key drivers in the current development of the IT (information technology) industry. But it may only exploit this opportunity if the about 70 known fairness metrics and about 10 known state-of-the-art bias mitigation approaches may find its way from research into practical applications and actual practice of domains as wide-ranging as finance, human capital management, healthcare, and education.

There are several disclosures related to a computer-implemented method for controlling a supervised machine-learning model:

Document U.S. Pat. No. 9,008,840 B1 discloses a framework for transferring knowledge from an external agent to a robotic controller. In an obstacle avoidance/target approach application, the controller may be configured to determine a teaching signal based on a sensory input, the teaching signal conveying information associated with target action consistent with a sensory input, wherein the sensory input is indicative of the target/obstacle.

Document US 2018/0012137 A1 discloses a control system and method for controlling a system which employs a dataset representing a plurality of states and associated trajectories of an environment of the system. It iteratively determines an estimate of an optimal control policy for the system.

A disadvantage of known solutions may be that they stay in the boundaries of their own setup so as to be flexible only within a given set of parameters. Thus, there may be a need to overcome the limitations of the currently known methods and systems, in particular to increase the fairness and to reduce bias of a machine-learning system in a much wider range than possible today.

### SUMMARY

According to one aspect of the present invention, a computer-implemented method for improving fairness and reducing discriminatory bias in a supervised machine-learning model may be provided. The method may comprise linking the supervised machine-learning model to a reinforcement learning meta model, selecting a list of hyper-parameters and parameters of the supervised machine-learning model, and controlling by the at least one aspect of the supervised machine-learning model by adjusting hyper-parameters values and parameter values of the list of hyper-parameters and parameters of the supervised machine-learning model by a reinforcement learning engine relating to the reinforcement learning meta model by calculating a reward function based on multiple conflicting objective functions.

According to another aspect of the present invention, a related fairness improvement system for improving fairness and reducing discriminatory bias in a supervised machine-learning model may be provided. The system may comprise a linking component adapted for linking the supervised machine-learning model to a reinforcement learning meta model, a selector unit adapted for selecting a list of hyper-parameters and parameters of the supervised machine-learning model, and a controller adapted for controlling at least one aspect of the supervised machine-learning model by adjusting hyper-parameters values and parameter values of the list of hyper-parameters and parameters of the supervised machine-learning model by a reinforcement learning engine relating to the reinforcement learning meta model by calculating a reward function based on multiple conflicting objective functions.

According to one preferred embodiment, the method may also comprise interrupting the repeating if a fairness value is greater than a predefined fairness threshold value and a performance value is greater than a predefined performance threshold value. Thus, both conditions may need to be fulfilled to determine that an optimized machine-learning model has been determined.

### BRIEF DESCRIPTION OF THE DRAWINGS

In the following, a detailed description of the figures will be given. All instructions in the figures are schematic. Firstly, a block diagram of an embodiment of the inventive computer-implemented method for improving fairness in a supervised machine-learning model is given. Afterwards, further embodiments, as well as embodiments of the fairness improvement system for improving fairness in a supervised machine-learning model, will be described. The aspects defined above, and further aspects of the present invention, are apparent from the examples of embodiments to be described hereinafter and are explained with reference to the examples of embodiments, but to which the invention is not limited.

Preferred embodiments of the invention will be described, by way of example only, and with reference to the following drawings:

FIG. 1 shows a flowchart of an embodiment of the inventive computer-implemented method for improving fairness and reducing discriminatory bias in a supervised machine-learning model.

FIG. 2 shows a block diagram of unwanted bias.

FIG. 3 shows a block diagram of a comprehensive flowchart summarizing the proposed concept on a high level.

FIG. 4 shows a block diagram of an embodiment of a landscape of different machine-learning model types and/or different model parameters.

FIG. 5 shows a flowchart of a set of interacting components.

FIG. 6 shows a flowchart, as an example, a credit scoring algorithm which may not have any gender bias.

FIG. 7 shows a block diagram of an embodiment of the fairness improvement system for improving fairness and reducing discriminatory bias in a supervised machine-learning model.

FIG. 8 shows a block diagram of an embodiment of a computing system comprising the system according to FIG. 7.

### DETAILED DESCRIPTION

In the context of this description, the following conventions, terms and/or expressions may be used:

The term ‘fairness’—expressed as fairness value—may denote in the context of this document that predictions of machine-learning systems and related algorithms may be unbiased in respect to specific protected attributes. In respect to these protected attributes (e.g., segmented relevant sub-groups, etc.)—e.g., gender, age, ethnicity, physical attributes, nationality, gender preference, gender attraction, gender identification, belief preference, etc.—predictions and/or classifications or other output values of machine-learning systems, the output generated shall be balanced, i.e., more or less equal. Thus, increasing a fairness value may also be interpreted as decreasing a bias value of an output of a machine-learning system.

The term ‘supervised machine-learning model’ (SML) may denote a model with related parameters as generated through a training process in which a machine-learning system “may learn” and optimize parameters of functions and weighing factors between the functions. Thus, the model can be seen as a set of parameters describing the setting of a specific machine-learning system. Such a machine-learning system may be trained by a training dataset comprising examples according to which the model is developed or develops itself in them machine-learning system. It may also be noted that the examples of the training dataset are annotated denoting what is expected as output value for the given input value from the machine-learning system. This way, also unknown data used as input to the machine learning system may be categorized according to the derived model (during the training phase).

The term ‘reinforcement learning meta model’ may denote—beside supervised machine-learning and unsupervised machine-learning—a third type of AI systems. It aims at using observations gathered from interactions with its environment to take actions that would maximize a reward function or minimize a given risk function. Thus, a reinforcement learning algorithm—typically implemented as an agent—may continuously learn from its environment using iterations. In the context of this document, the iterations are performed regarding changes to parameters and hyper-parameters of the supervised machine-learning model, whereas the reward function may be seen as a combination of the constrains, i.e., a fairness value being greater than a predefined threshold and a minimum performance of the machine-learning system.

The term ‘parameters’ may denote describing variables of a given machine-learning algorithm or related system. E.g., for a neural network, the weighing factors between the artificial neurons of different layers as well as activation functions and offsets may be seen as parameters. In contrast to this, hyper-parameters may describe the machine-learning model itself. E.g., the type itself, for a neural network, the number of input neurons, the number of output neurons, the number of neurons per hidden layer, as well as the number of hidden layers may be denoted as hyper-parameters. Thus, the hyper-parameters may describe the architecture of the machine-learning model, whereas the parameters of the same machine-learning model describe internal variables that may be adapted during the training process.

The term ‘reward function’ may denote—depending on the problem at hand—a function that may be maximized or minimized in a learning process of a reinforcement machine-learning system. The agent—which may try to optimize the reward function—of the reinforcement machine-learning system may also be responsible for “experimenting” (i.e., interacting with its environment by changing parameters) iteratively with environmental parameters. In the proposed concept, these environmental parameters may be the parameters of the machine-learning model as well as related hyper-parameters.

The term ‘conflicting objective functions’ may denote a performance value and a fairness value fairness which should be optimized the same time. Also at least a third variable—e.g., a preciseness of the machine-learning model—may also be taken into account as objective function. Thus, the performance value as well as the fairness value should each reach a minimum threshold value during a given maximum number of iterations.

The term ‘F-score algorithm’—also F1 score—may denote a measure of a test's accuracy. It may consider both, the precision and the recall of the test to compute the score. Thereby, the precision may denote the number of correct positive results divided by the number of all positive results returned by a classifier, wherein the recall value is the number of correct positive results divided by the number of all relevant samples (all samples that should have been identified as positive). The F-score may also be seen as the harmonic average of the precision and recall, were an F-score reaches its best value at 1 (perfect position and perfect recall) and worst at 0.

The term ‘algorithmic bias’ may denote a bias for which the selected algorithm may be responsible. It may also reflect implicit values of the programmers who are involved in coding, collecting, selecting or using it in the data for a training of the machine-learning algorithm.

The term ‘sample bias’ may denote a bias given through the data said being used for a training of a machine-learning model. If the dataset may comprise 90% of data relating to men and only 10% of data relating to women, it may be obvious that the sample is biased in respect to data regarding men.

The term ‘prejudicial bias’ may somehow relate to the ‘sample bias’ and may denote a conscious manipulation of sample data for a training of a machine-learning system due to unproven assumptions of a programmer, a developer or a human trainer of a supervised machine-learning model.

The term ‘measurement bias’ may denote a systematic error that may skew all data due to faulty measurements, and its results in a systematic distortion of data.

The term ‘reinforcement learning cycle’ may denote here a training cycle of the supervised machine-learning model and an assessment of the related reward function. During a next cycle, the reinforcement learning system may change parameters, and/or hyper-parameters of the underlying supervised machine-learning model to be optimized.

The term ‘reinforcement agent’ may denote one implementation option for a reinforcement machine-learning system. The reinforcement agent may change parameters and/or hyper-parameters of the supervised machine-learning model in order to optimize this. In this sense, the environment of the reinforcement learning model may be the supervised machine-learning model.

The term ‘neural network’ may denote a brain-inspired network of artificial neurons connected by edges having a weight. Typically, a neural network may be organized as a number of layers of neurons—an input layer, a plurality of hidden layers and an output layer—wherein each artificial neuron may comprise an activation function. During training by example using annotated datasets, the neural network may adapt its parameters—i.e., weighing factors and activation function variables—in order to deliver output values based on an unknown input dataset according to the model which has been determined during the training phase.

The term ‘logistic regression model’ may denote the widely used statistical model that, in its basic form, may use a logistic function to model a binary dependent variable; many more complex extensions exist. In regression analysis, logistic regression (or logit regression) may estimate the parameters of a logistic model; it is a form of binomial regression. Mathematically, a binary logistic model has a dependent variable with two possible values, such as pass/fail, win/lose, alive/dead or healthy/sick; these are represented by an indicator variable, where the two values are labeled “0” and “1”. In the logistic model, the log-odds (the logarithm of the odds) for the value labeled “1” is a linear combination of one or more independent variables (“predictors”); the independent variables can each be a binary variable (two classes, coded by an indicator variable) or a continuous variable (any real value). The corresponding probability of the value labeled “1” can vary between 0 (certainly the value “0”) and 1 (certainly the value “1”), hence the labeling; the function that converts log-odds to probability is the logistic function, hence the name.

The term ‘random forest model’ may denote the known machine-learning method for classification, regression and other tasks that operate by constructing a multitude of decision trees at learning time and outputting the class that is the mode of the classes (classification) or mean prediction (regression) of the individual trees.

The term ‘support-vector machine’ may denote the known supervised machine-learning model with its associated machine-learning algorithm that may analyze data used for classification and regression analysis. A support-vector machine model may be understood as a representation of the examples as points in space mapped, so that the examples of the separate categories are divided by a clear gap that is as wide as possible. New examples may then be mapped into the same space and predicted to belong to a category based on which side of the gap they fall.

The term ‘protected attribute’ may denote a variable in a dataset (either training dataset or query dataset) in which respect the supervised machine-learning model should be neutral, i.e., unbiased. One example may be the gender of a group of people (e.g., segmented relevant sub-groups, etc.). Output values of the machine-learning model should be roughly the same for different genders.

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

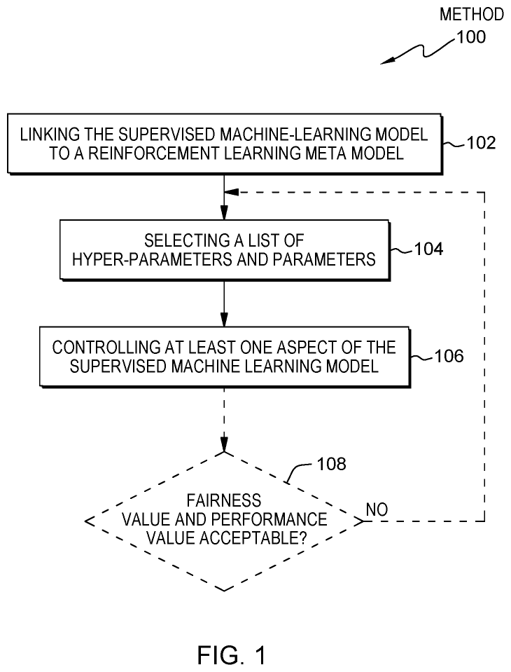

FIG. 1 shows a block diagram of an embodiment of the computer-implemented method 100 for improving fairness and reducing discriminatory bias in a supervised machine-learning model. The method comprises linking, 102, the supervised machine-learning model (MLM) to a reinforcement learning meta-model (RLMM), selecting, 104, a list of hyper-parameters and parameters of the supervised machine-learning model which may be seen as the initial setting of supervised machine-learning model. In some embodiments the selection of parameters may be done randomly. During linking, the RLMM controls and configures the supervised MLM. It is noted that linking (i.e., control and configure) the supervised machine-learning model by the reinforcement learning meta-model involves at least two factors, a configuration and a read out. A configuration involves the system tuning and adjusting various parameters on the model. A read out involves system observing the prediction and calculating the reward optimally.

However, it may be noted that it is useful to differentiate between hyper-parameters as the “outer variables or parameters” of a machine-learning mode, defining characteristics like—for a neural network—the type of activation function, the number of nodes per layer, the number of layers in case of a neural network, or the machine-learning model itself, and parameters for the supervised-learning model like the learned variables, in particular weighing factor of edges linking the artificial neurons, as well as activation functions and offsets (internal variables or parameters).

The method 100 may also comprise controlling, 106, at least one aspect—in particular relating to one protected value—of the supervised machine-learning model by adjusting hyper-parameters values and parameter values of the list of hyper-parameters and parameters of the supervised machine-learning model by a reinforcement learning engine relating to the reinforcement learning meta model by calculating a reward function based on multiple conflicting objective functions.

Thereby, the reward function may be a metric specifying how good that reinforcement engine reaches its target which may be defined by a performance metric, a preciseness metric, and a fairness metric.

Last but not least, the method 100 comprises an iterative repetition of the steps of selecting and controlling for improving a fairness value of the supervised machine-learning model. For this purpose, a determination 108 is made whether the target fairness value (controlled by a defined threshold value) and the target performance value are acceptable in combination. It is noted that a YES (not shown) branch of step 108 would indicated that step 108 has achieved the target fairness value that is acceptable based on the threshold and target performance value. Otherwise, a “NO” branch of step 108 would repeat back to step 104.

In an alternative embodiment, the method may comprise of receiving an original version of machine learn receiving an original version of a machine learning model (MLM) including a plurality of parameter values, a plurality of hyperparameter values and an original fairness value that reflects fairness with respect to segmented relevant sub-groups. Furthermore, in the same alternate embodiment, the method may adjust at least some of the parameter values and/or at least some of the hyperparameter values of the original version of the MLM to create a provisional version of the MLM. After adjusting the parameters, the method may determine a fairness value for the provisional version of the MLM by operations including the following: receiving a reinforcement learning meta model (RLMM) that defines a plurality of fairness related objectives and a reward function reflecting the plurality of fairness related objectives; operating the provisional version of the MLM; during the operation of the provisional version of the MLM, calculating, by the RLMM, reward values based on the reward function; and determining a provisional fairness value for the provisional version of the MLM based upon the reward values. In the same alternate embodiment, the method can determine that the provisional fairness value is greater than the original fairness value and replace the original version of the MLM with the provisional version of the MLM and replacing the original fairness value with the provisional fairness value.

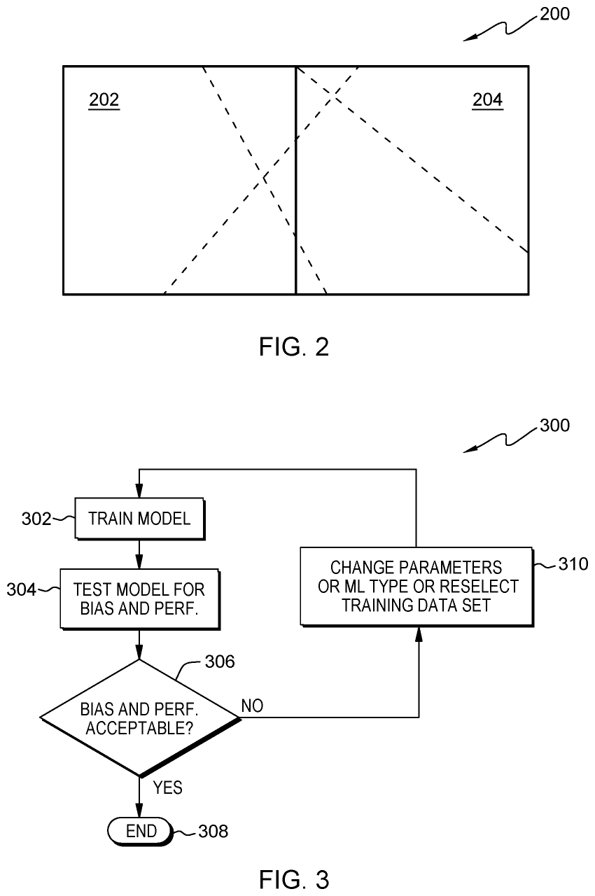

FIG. 2 shows a block diagram of unwanted bias. Assuming that the rectangle 200 represents a data-lake, a machine-learning model should be trained having not any bias, as shown by the dashed lines. If 202 may represent a male population of the data-lake 200 and 204 represents a female population of the data-lake, an ideally trained system may return as many male predictions as female predictions, i.e., according to the vertical line between the areas 202 and 204.

Generally, in supervised machine-learning, a model is trained based on a dataset in order to optimize some performance metric such as F-score or the area under the receiver operation characteristic (ROC) curve. Testing for bias could then be accomplished by taking a subset of the data and checking whether any unwanted preference is given to a certain sub-group. In the illustration of FIG. 2, this testing would be accomplished, e.g., by considering the male and female subset. Thereby, it is assumed that the standard machine-learning practice is to partition the dataset into training, testing, and validation datasets. However, this general approach has no impact on the here presented idea.

After testing the male and female subsets, one could determine whether there is a gender bias. If there is such a bias, one would have to manually go back and change the training setup. For example, this could include changing the male/female training set ratio manually. It is obvious that this is an inefficient process. Alternatively, the bias metric could be included in addition to the performance metric(s) in the optimization process. However, such multi-target optimization can be complex and time-consuming.

FIG. 3 shows a block diagram of a comprehensive flowchart 300 summarizing the proposed concept on a high level. At 302, the supervised machine-learning model is trained. It is then tested, 304 bias and performance, after which a determination 306 is made whether the determined bias at determined performance values are acceptable and within predetermined limits. If that is the case—case “Y”—the process ends and the supervised machine-learning model is trained.

In case the determination 306 does not have a positive outcome—case “N”—parameters of the machine-learning model can be changed or the machine-learning type is changed or a re-selection of a training data is performed under the control of the reinforcement learning engine (310). Using these new parameters and/or hyper-parameters, the process of training 302 the machine-learning model starts again. Otherwise it ends, 308.

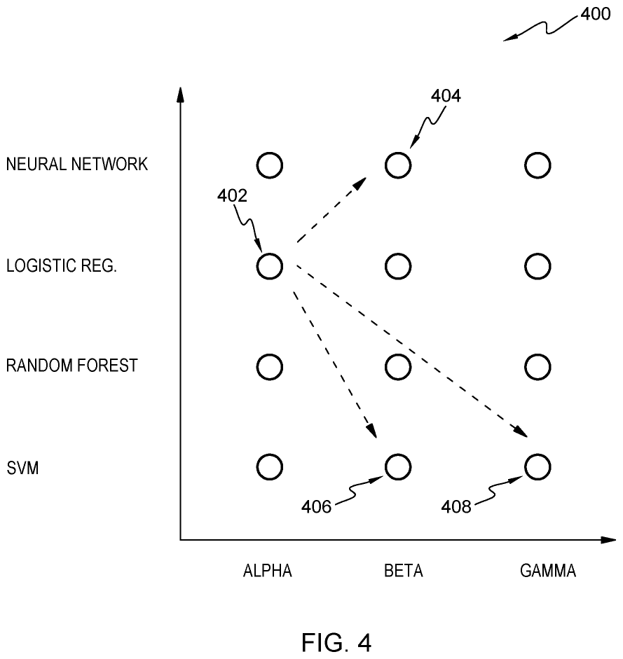

FIG. 4 shows a block diagram of an embodiment of a landscape 400 of different machine-learning model types and/or different model parameters. The landscape 400 is shown as an x-y-chart. On the y-axis, machine-learning model types are shown (non-limiting), e.g., a neural network, a logistic regression engine, a random forest engine and a support-vector machine. Each of these machine-learning models may have parameter and/or hyper-parameter datasets (not to be confused with the training dataset), exemplary denoted as “alpha”, “beta” and “gamma”.

Using this model landscape, it becomes comprehensible that reinforcement learning can be used to mitigate bias in supervised machine-learning models through suitable parameter tuning. An agent operates in a multi-dimensional landscape (here shown as two dimensional for simplicity reasons) of different machine-learning model types and sets of model parameters.

The agent navigates this landscape, making suitable exploit-explore decisions, in a reinforcement learning setting. This setting includes an optimization of at least one target parameter, such as F-score, and a bias target threshold. In other words, the final machine-learning model should perform as well as possible while not exhibiting bias beyond a certain threshold. Hence, starting, for example, from the logistic regression model 402 with the parameter and/or hyper-parameter datasets alpha, an iteration step may lead to a neural network with parameter and/or hyper-parameter dataset beta (404), an SVM with parameter and/or hyper-parameter dataset, beta (406) or gamma (408). Basically, any other machine learning model with any other suitable set of parameter and/or hyper-parameter dataset may be chosen.

This approach has the advantage that a large space of possible machine-learning model types and parameters/hyper-parameters can be efficiently explored in order to arrive at a machine-learning model that is performance-metric optimized and within the accepted bias metric range.

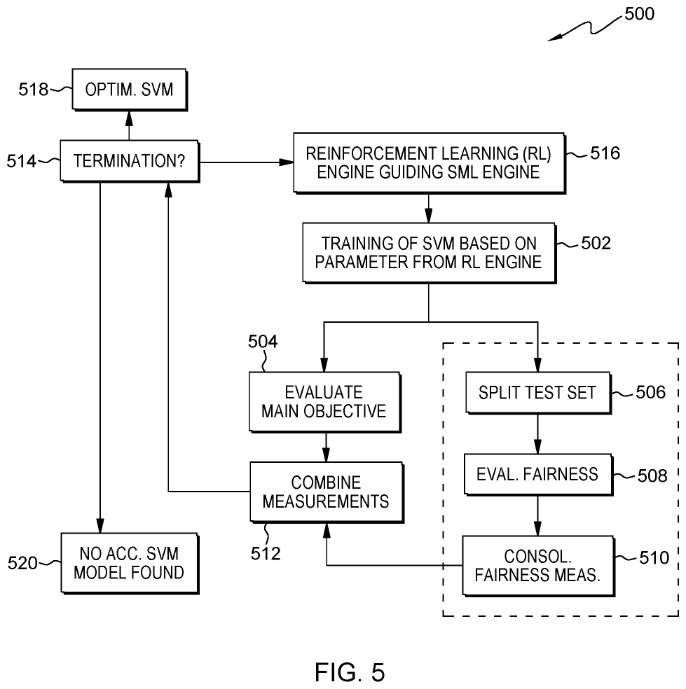

FIG. 5 shows a block diagram 500 of a set of interacting components which fall into three phases/three categories: controlling, training, and evaluation.

The controlling portion is symbolized by the blocks 514 and 516. At the core of this approach is a reinforcement learning (RL) engine 516 which is tasked with controlling a supervised machine-learning model to optimize both, fairness and performance. To this end, the RL engine navigates the space of possible machine-learning models (compare FIG. 4) and model parameters as well as hyper-parameters by calculating a reward which is based both, on performance and fairness of the predictions by the supervised machine-learning model. The reinforcement learning engine 516 will iteratively optimize this reward function value by exploring several different configurations of the supervised machine-learning model, and the termination engine 514 determines that a suitable predictor has been found based on the convergence of the reward function. The termination engine 514 may also have other explicit criteria that must be fulfilled before termination occurs, e.g., constraints on the achieved fairness. If the reward function outcomes have converged and the supervised machine-learning model meets the pre-specified performance and fairness requirements, the optimized supervised machine-learning model (SML) is presented as a result, 518 (and the maximum number of allowed iterations has not been exceeded). Otherwise, it is assumed that no suitable model could be found, 520. Thus, at this point, the model is not optimized (fairness or performance are not acceptable but a maximum number of iterations has been reached).

The training portion is symbolized by the block 502. In each iteration, the output of the reinforcement learning engine 516 determines the configuration of a supervised machine-learning (SML) model, i.e., the type of the model as well as its parameters and hyper-parameters. The resulting supervised machine-learning model is then trained using a set of attributes with corresponding labels, referred to as the training dataset. The supervised machine-learning model performs a three-step process consisting of pre-processing, training and post-processing. All three of these steps are configurable by the reinforcement learning engine 516. Here, pre-processing includes transformation of the training dataset, e.g., through normalization, rebalancing or the mentioned nullity reduction. The training phase then aims at learning the parameters of the SML model to enable a prediction of the labels from the output of the pre-processing step. Any algorithm that is suitable for finding the model parameters may be used. Finally, the predictions generated by the model can be subject to post-processing steps such as scaling, thresholding, or combinations thereof. It may be noted that the training of this model to learn its parameters, which in itself is often an iterative process, represents one step of the controlling reinforcement learning engine.

The evaluation portion may be symbolized by the blocks 504, 506, 508, 510, 512. After the supervised machine-learning model has been trained, it is evaluated with respect to both, prediction performance and prediction fairness. This is achieved by letting the trained supervised machine-learning model perform a set of predictions on a validation dataset that has not been used in the training process of the SML model. The quantities are then calculated from the resulting predictions: a performance metric and a fairness metric. This specification of these metrics depends on a problem at hand. An example of a performance metric is F-score. An example of a fairness metric is the average relative difference between data samples that only differ on protected attributes. This may be done by splitting a test dataset of pre-selected critical/protected features, 506, and by evaluating a fairness measurement on each of the subsets, 508. After that, a part of the evaluation phase may also be a consolidation of the different fairness measures (e.g., max-function, median, etc.). Both metrics—i.e., performance and fairness—are then used as input into a reward function, 512. This may be an F-score function with heavy penalty if a fairness measurement is too low.

The specification on this function again depends on the problem. An example of a reward function is the ratio of the performance metric (F-score) to the fairness metric (average relative difference between data samples that only differ in protected attributes), 504. The output of the reward function is then passed to the controlling reinforcement learning engine, which may either begin the next duration or terminate the optimization process, 514.

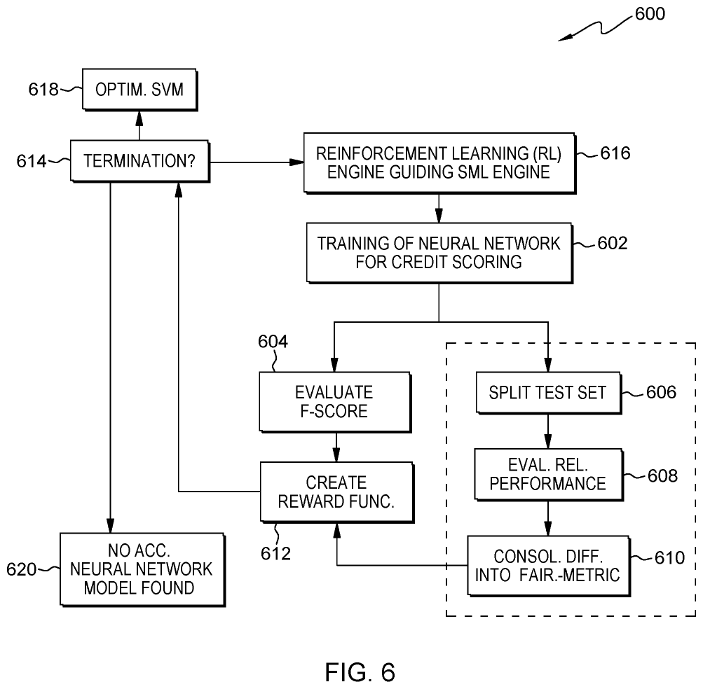

FIG. 6 shows the general approach, as discussed in the context of FIG. 5, implemented as an example for a credit scoring algorithm 600 which must not have a gender bias (in the following called protected parameters). There are, however, multiple other attributes such as income, wealth, and others that are expected to have a significant effect on the assignment of a credit score.

An SML model for predicting a credit score based on a set of attributes (protected ones and other attributes) is set up. In this example, a neural network (NN) is used, but any other SML algorithm can be applied. The NN model has a set of hyper-parameters that define the model (e.g., the number of layers, the amount of oversampling, the learning rate, etc.). The type of model itself can also be a hyper-parameter. The hyper-parameters are initialized randomly, and the model is trained, 602, using training data (stunner training process of the SML algorithm).

The performance metric of the model is evaluated, 604, by computing the F-score on the test dataset. To illustrate the example, an F-score of 0.8 is assumed for this iteration.

Next, the bias on the protected metric (e.g., gender) is measured. In this example, this is done by randomly sampling a set of 100 women and a matching set of 100 men that match the selected women as closely as possible on all attributes except the gender, 606. A fair evaluation (608) would require each pair to have a similar credit score, any differences are summarized, 610 into the fairness metric. In this example, the fairness metric is calculated as the average relative difference between all pairs. In any other method of measuring bias is acceptable as well. To illustrate the example, a fairness metric value of 10% (average relative difference) is assumed.

For the later used reinforcement learning algorithm a reward function is computed, 612, which is a combination of performance and bias. In this example, this is given by the sum of the F-score and bias metric. The bias metric is in this example defined as

(−1) if fairness metric>0.1%,

0 if fairness metric<0.1%.

In the case of the example, therefore a reward of R=0.8−1=−0.2 (since 10%>0.1%) is fed to the RL network.

A termination engine 614 uses the computed reward to decide if any iteration is to be initiated. It terminates the process if a defined maximum number of iterations is reached or if the reward is not improving anymore (no convergence). It may also be specified that the fairness metric must be lower than 0.1% to terminate. In case of the discussed example, it is also assumed that the termination engine initiates a further iteration; thus, the SML model can be further optimized. Thus, the termination engine 614 determines that an optimized SML—e.g., an optimized support-vector machine (SVM) or neural network (NN) has been found, 618, or not, 620, within the predefined number of allowed iterations.

By going through multiple iterations, the RL engine 616 therefore finds an optimal combination of parameters and/or hyper-parameters that decreases the bias under the specified threshold while maintaining a high performance which results in a fair credit scoring across gender.

In a next step, the RL engine uses the computed reward to efficiently optimize the parameters and/or hyper-parameters of the SML model. Optimizing for a reward leads to a minimization of the bias as measured by the fairness metric, and/or an improvement of the model performance as measured by the F-score. In the case of credit scoring, the RL model can be a multi-layer neural network that uses the reward to tune the supervised network hyper-parameters (for example by changing its number of layers, the amount of oversampling, the learning rate, etc.).

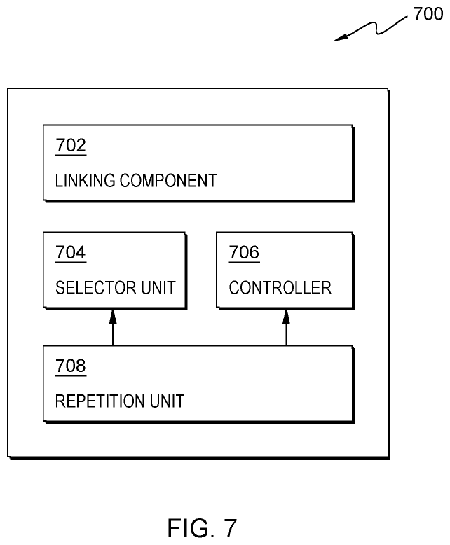

For completeness reasons, FIG. 7 shows a block diagram of an embodiment of the fairness improvement system for improving fairness and reducing discriminatory bias in a supervised machine-learning model. The system comprises a linking component 702 adapted for linking the supervised machine-learning model to a reinforcement learning meta model, a selector unit 704 adapted for selecting a list of parameters of the supervised machine-learning model, and a controller 706 adapted for controlling at least one aspect of the supervised machine-learning model by adjusting parameter values of the list of parameters of the supervised machine-learning model by calculating a reward function based on multiple conflicting objective functions.

Last but not least, a repetition unit 708 is adapted for triggering the selector unit and the controller iteratively for an improvement of a fairness value of the supervised machine-learning model.

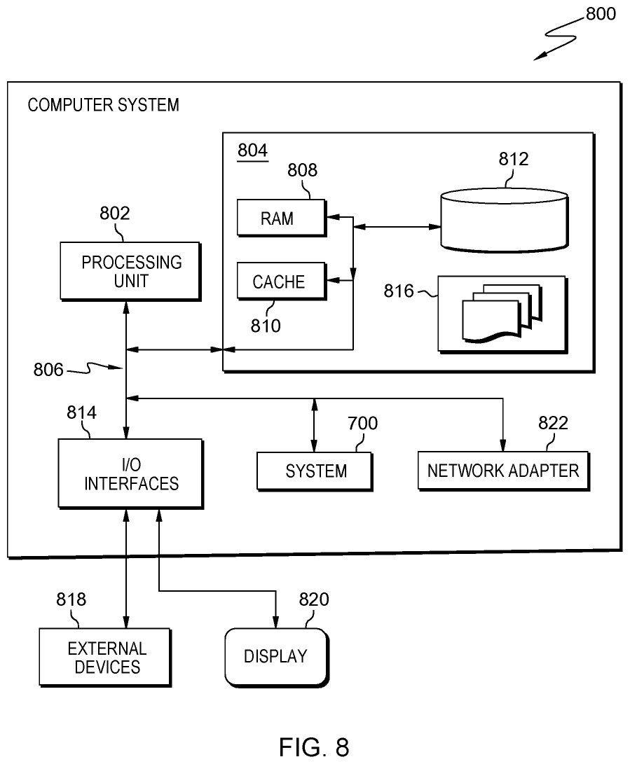

Embodiments of the invention may be implemented together with virtually any type of computer, regardless of the platform being suitable for storing and/or executing program code. FIG. 8 shows, as an example, a computing system 800 suitable for executing program code related to the proposed method.

The computing system 800 is only one example of a suitable computer system, and is not intended to suggest any limitation as to the scope of use or functionality of embodiments of the invention described herein, regardless, whether the computer system 800 is capable of being implemented and/or performing any of the functionality set forth hereinabove. In the computer system 800, there are components, which are operational with numerous other general purpose or special purpose computing system environments or configurations. Examples of well-known computing systems, environments, and/or configurations that may be suitable for use with computer system/server 800 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 800 may be described in the general context of computer system-executable instructions, such as program modules, being executed by a computer system 800. Generally, program modules may include routines, programs, objects, components, logic, data structures, and so on that perform particular tasks or implement particular abstract data types. Computer system/server 800 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 800 is shown in the form of a general-purpose computing device. The components of computer system/server 800 may include, but are not limited to, one or more processors or processing units 802, a system memory 804, and a bus 806 that couple various system components including system memory 804 to the one or more processors or processing units 802. Bus 806 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 800 typically includes a variety of computer system readable media. Such media may be any available media that is accessible by computer system/server 800, and it includes both, volatile and non-volatile media, removable and non-removable media.

The system memory 804 may include computer system readable media in the form of volatile memory, such as random access memory (RAM) 808 and/or cache memory 810. Computer system/server 800 may further include other removable/non-removable, volatile/non-volatile computer system storage media. By way of example only, a storage system 812 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 806 by one or more data media interfaces. As will be further depicted and described below, memory 804 may include at least one program product having a set (e.g., at least one) of program modules that are configured to carry out the functions of embodiments of the invention.

The program/utility, having a set (at least one) of program modules 816, may be stored in memory 804 by way of example, and not limiting, as well as an operating system, one or more application programs, other program modules, and program data. Each of the operating systems, one or more application programs, other program modules, and program data or some combination thereof, may include an implementation of a networking environment. Program modules 816 generally carry out the functions and/or methodologies of embodiments of the invention, as described herein.

The computer system/server 800 may also communicate with one or more external devices 818 such as a keyboard, a pointing device, a display 820, etc.; one or more devices that enable a user to interact with computer system/server 800; and/or any devices (e.g., network card, modem, etc.) that enable computer system/server 800 to communicate with one or more other computing devices. Such communication can occur via Input/Output (I/O) interfaces 814. Still yet, computer system/server 800 may communicate with one or more networks such as a local area network (LAN), a general wide area network (WAN), and/or a public network (e.g., the Internet) via network adapter 822. As depicted, network adapter 822 may communicate with the other components of the computer system/server 800 via bus 806. It should be understood that, although not shown, other hardware and/or software components could be used in conjunction with computer system/server 800. Examples, include, but are not limited to: microcode, device drivers, redundant processing units, external disk drive arrays, RAID systems, tape drives, and data archival storage systems, etc.

Additionally, the fairness improvement system 700 for improving fairness in a supervised machine-learning model may be attached to the bus 806.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

Finally, the proposed concept may be summarized in a nutshell in the following clauses:
1. A computer-implemented method for improving fairness and reducing discriminatory bias in a supervised machine-learning model, the method comprising
   linking the supervised machine-learning model to a reinforcement learning meta model,
   selecting a list of hyper-parameters and parameters of the supervised machine-learning model,
   controlling at least one aspect of the supervised machine-learning model by adjusting hyper-parameters values and parameter values of the list of hyper-parameters and parameters of the supervised machine-learning model by reinforcement learning engine relating to the reinforcement learning meta model by calculating a reward function based on multiple conflicting objective functions,
   repeating iteratively the steps of selecting and controlling for improving a fairness value of the supervised machine-learning model.
2. The method according to clause 1, also comprising
   interrupting the repeating if a fairness value is greater than a predefined fairness threshold value, and a performance value is greater than a predefined performance threshold value.
3. The method according to clause 2, also comprising
   selecting a new supervised machine-learning model if, after a predefined number of iterations, the fairness value is smaller than the predefined fairness threshold value or the performance value is smaller than the predefined performance threshold value.
4. The method according to clause 2, wherein the performance value is selected out of the group comprising a speed value, a prediction quality value, a number of cycles.
5. The method according to clause 4, also comprising
   determining the prediction quality value using F-score, recall and precision and/or accuracy.
6. The method according to any of the previous clauses, wherein the fairness value is determined with respect to algorithmic bias, sample bias, prejudicial bias or measurement bias.
7. The method according to any of the previous clauses, wherein the reward function is a component of a reinforcement learning cycle.
8. The method according to clause 7, also comprising
   executing a reinforcement agent for controlling the reinforcement learning cycle.
9. The method according to any of the previous clauses, wherein the supervised machine-learning model is selected out of the group comprising a neural network, a logistic regression model, a random forest model, a model of a support-vector machine, and a decision tree model.
10. The method according to any of the previous clauses, wherein the conflicting objective functions comprise at least two selected out of the group comprising a performance metric, a preciseness metric or a fairness metric.
11. The method according to any of the previous clauses, wherein the fairness value is determined by an average relative difference between sample data that only differ in values of a protected attribute.
12. The method according to clause 2 to 11, also comprising
   upon determining that the fairness value is smaller than the predefined performance threshold value,
   modifying the supervised machine-learning model by changing the hyper-parameters, wherein the hyper-parameters relate to supervised machine-learning model type, its configuration, a pre-procession step and/or post-processing step, or changing the parameters of the supervised machine-learning model.
13. A fairness improvement system for improving fairness and reducing discriminatory bias in a supervised machine-learning model, the system comprising
   a linking component adapted for linking the supervised machine-learning model to a reinforcement learning meta model,
   a selector unit adapted for selecting a list of hyper-parameters and parameters of the supervised machine-learning model,
   a controller adapted for controlling at least one aspect of the supervised machine-learning model by adjusting hyper-parameters values and parameter values of the list of hyper-parameters and parameters of the supervised machine-learning model by a reinforcement learning engine relating the reinforcement learning meta model by calculating a reward function based on multiple conflicting objective functions,
   a repetition unit adapted for triggering the selector unit and the controller iteratively for an improvement of a fairness value of the supervised machine-learning model.
14. The system according to clause 13, also comprising
   interrupting the repeating if a fairness value is greater than a predefined fairness threshold value and a performance value is greater than a predefined performance threshold value.
15. The system according to clause 14, also comprising
   selecting a new supervised machine-learning model if, after a predefined number of iterations, the fairness value is smaller than the predefined fairness threshold value or the performance value is smaller than the predefined performance threshold value.
16. The system according to clause 13, wherein the performance value is selected out of the group comprising a speed value, a prediction quality value, a number of cycles.
17. The system according to clause 16, also comprising
   a determination unit adapted for determining the prediction quality value using F-score, recall and precision and/or accuracy.
18. The system according to any of the clauses 13 to 17, wherein the fairness value is determined with respect to algorithmic bias, sample bias, prejudicial bias or measurement bias.
19. The system according to any of the clauses 13 to 18, wherein the reward function is a component of a reinforcement learning cycle.
20. The system according to clause 19, also comprising
   reinforcement agent system for controlling the reinforcement learning cycle.
21. The system according to any of the clauses 13 to 20, wherein the supervised machine-learning model is selected out of the group comprising a neural network, a logistic regression model, a random forest model, a model of a support-vector machine, and a decision tree model.
22. The system according to any of the clauses 13 to 21, wherein the conflicting objective function comprise at least two selected out of the group comprising a performance metric, a preciseness metric or a fairness metric.
23. The method according to any of the clauses 13 to 22, wherein the fairness value is determined by an average relative difference between sample data that only differ in values of a protected attribute.
24. The method according to any of the clauses 14 to 23, wherein the repetition unit is adapted for:
   upon determining that the fairness value is smaller than the predefined performance threshold value, determining a dimension in a used training dataset in which one feature of the training dataset has the largest imbalance, and selecting a subset of the used training dataset for which the determined dimension has a number of data vectors that is equal for all variants for the dimension value plus a predefined delta value.
25. A computer program product for improving fairness in a supervised machine-learning model, the computer program product comprising a computer readable storage medium having program instructions embodied therewith, the program instructions being executable by one or more computing systems or controllers to cause the one or more computing systems to
   link the supervised machine-learning model to a reinforcement learning meta model,
   select a list of hyper-parameters and parameters of the supervised machine-learning model,
   control at least one aspect of the supervised machine-learning model by adjusting hyper-parameters values and parameter values of the list of hyper-parameters and parameters of the supervised machine-learning model by calculating a reward function based on multiple conflicting objective functions,
   repeat iteratively the steps of selecting and controlling for improving a fairness value of the supervised machine-learning model.

What is claimed is:

1. A computer-implemented method, the method comprising:
receiving an original version of a machine learning model (MLM) including a plurality of parameter values, a plurality of hyperparameter values and an original fairness value that reflects fairness with respect to segmented relevant sub-groups;
adjusting at least some of the parameter values and/or at least some of the hyperparameter values of the original version of the MLM to create a provisional version of the MLM;
determining a fairness value for the provisional version of the MLM by operations including the following:
receiving a reinforcement learning meta model (RLMM) that defines a plurality of fairness related objectives and a reward function reflecting the plurality of fairness related objectives;
operating the provisional version of the MLM;
during the operation of the provisional version of the MLM, calculating, by the RLMM, reward values based on the reward function; and
determining a provisional fairness value for the provisional version of the MLM based upon the reward values;
determining that the provisional fairness value is greater than the original fairness value; and
responsive to the determination that the provisional fairness value is greater than the original fairness value, replacing the original version of the MLM with the provisional version of the MLM and replacing the original fairness value with the provisional fairness value.

2. The computer-implemented method of claim 1, further comprising:
iteratively repeating the operations of until the original fairness value exceeds a predetermined threshold.

3. The computer-implemented method of claim 1, wherein the original MLM is a supervised MLM.

4. The computer-implemented method of claim 1, wherein the fairness related objectives include at least one of the following: gender, age, nationality, religious beliefs, ethnicity and orientation.

5. The computer-implemented method of claim 1, further comprising:
linking the original MLM to the reinforcement learning meta model based on a configuration and a read out.

6. The computer-implemented method of claim 1, wherein the plurality of parameter values includes a value for at least one of the following parameter types: weighing factors and activation function variables.

7. The computer-implemented method of claim 1, wherein the plurality of hyperparameter values include a value for at least one of the following hyperparameter types: type of activation function, number of nodes per layer, number of layers of a neural network and machine-learning model.

8. A computer program product, the computer program product comprising:
one or more non-transitory computer readable storage media and program instructions stored on the one or more non-transitory computer readable storage media, the program instructions comprising:
program instructions to receive an original version of a machine learning model (MLM) including a plurality of parameter values, a plurality of hyperparameter values and an original fairness value that reflects fairness with respect to segmented relevant sub-groups;
program instructions to adjust at least some of the parameter values and/or at least some of the hyperparameter values of the original version of the MLM to create a provisional version of the MLM;
program instructions to determine a fairness value for the provisional version of the MLM by operations including the following:
program instructions to receive a reinforcement learning meta model (RLMM) that defines a plurality of fairness related objectives and a reward function reflecting the plurality of fairness related objectives;
program instructions to operate the provisional version of the MLM;
during the operation of the provisional version of the MLM, program instructions to calculate, by the RLMM, reward values based on the reward function; and
program instructions to determine a provisional fairness value for the provisional version of the MLM based upon the reward values;
program instructions to determine that the provisional fairness value is greater than the original fairness value; and
responsive to the determination that the provisional fairness value is greater than the original fairness value, program instructions to replace the original version of the MLM with the provisional version of the MLM and replacing the original fairness value with the provisional fairness value.

9. The computer program product of claim 8, further comprising:
program instructions to iteratively repeating the operations of until the original fairness value exceeds a predetermined threshold.

10. The computer program product of claim 8, wherein the original MLM is a supervised MLM.

11. The computer program product of claim 8, wherein the fairness related objectives include at least one of the following: gender, age, nationality, religious beliefs, ethnicity and orientation.

12. The computer program product of claim 8, further comprising:
program instructions to link the original MLM to the reinforcement learning meta model based on a configuration and a read out.

13. The computer program product of claim 8, wherein the plurality of parameter values includes a value for at least one of the following parameter types: weighing factors and activation function variables.

14. The computer program product of claim 8, wherein the plurality of hyperparameter values include a value for at least one of the following hyperparameter types: type of activation function, number of nodes per layer, number of layers of a neural network and machine-learning model.

15. A computer system, the computer system comprising:
one or more computer processors;
one or more computer readable storage media;
program instructions stored on the one or more computer readable storage media for execution by at least one of the one or more computer processors, the program instructions comprising:
program instructions to receive an original version of a machine learning model (MLM) including a plurality of parameter values, a plurality of hyperparameter values and an original fairness value that reflects fairness with respect to segmented relevant sub-groups;
program instructions to adjust at least some of the parameter values and/or at least some of the hyperparameter values of the original version of the MLM to create a provisional version of the MLM;
program instructions to determine a fairness value for the provisional version of the MLM by operations including the following:
program instructions to receive a reinforcement learning meta model (RLMM) that defines a plurality of fairness related objectives and a reward function reflecting the plurality of fairness related objectives;
program instructions to operate the provisional version of the MLM;
during the operation of the provisional version of the MLM, program instructions to calculate, by the RLMM, reward values based on the reward function; and
program instructions to determine a provisional fairness value for the provisional version of the MLM based upon the reward values;
program instructions to determine that the provisional fairness value is greater than the original fairness value; and
responsive to the determination that the provisional fairness value is greater than the original fairness value, program instructions to replace the original version of the MLM with the provisional version of the MLM and replacing the original fairness value with the provisional fairness value.

16. The computer system of claim 15, further comprising:
program instructions to iteratively repeating the operations of until the original fairness value exceeds a predetermined threshold.

17. The computer system of claim 15, wherein the fairness related objectives include at least one of the following: gender, age, nationality, religious beliefs, ethnicity and orientation.

18. The computer system of claim 15, further comprising:
program instructions to link the original MLM to the reinforcement learning meta model based on a configuration and a read out.

19. The computer system of claim 15, wherein the plurality of parameter values includes a value for at least one of the following parameter types: weighing factors and activation function variables.

20. The computer system of claim 15, wherein the plurality of hyperparameter values include a value for at least one of the following hyperparameter types: type of activation function, number of nodes per layer, number of layers of a neural network and machine-learning model.
